(19) United States
(12) Patent Application Publication
(10) Pub. No.: US 2009/0281791 A1
(43) Pub. Date: Nov. 12, 2009

(54) UNIFIED TAGGING OF TOKENS FOR TEXT NORMALIZATION

(75) Inventor: Hang Li, Beijing (CN)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/117,740

(22) Filed: May 9, 2008

(51) Int. Cl. G06F 17/27

(52) U.S. Cl. 704/9

(57) ABSTRACT

Raw input text is received, and divided into sequences of tokens. Each token is marked with a text normalization tag that identifies a text normalization operation to be performed on the token during text normalization. The tags are assigned to the tokens by determining a most likely tag sequence, given the sequence of tokens being processed. The text normalization operations are performed on the tokens in order to provide clean output text, which can be output for further natural language processing.

### BACKGROUND

It has become popular to submit text from a wide variety of input sources to natural language processing systems in order to perform natural language processing on the input text. For instance, in some applications, it may be desirable to submit the text of electronic mail messages (emails) to a natural language processor in order to automatically determine the meaning of the textual language in the email messages. This can be done for a variety of different reasons. The particular reasons that natural language processing is performed on such text is not important to the present invention.

Similarly, some have attempted to submit textual information from newsgroups, online forums, and blogs, to natural language processing components in order to perform natural language processing on these textual items as well. The text from these different sources is referred to as “raw text” because it is usually input by a user in an informal manner. In other words, text that is input in an informal manner is usually very noisy, and may not be properly segmented. For example, such text may contain extra line breaks, extra spaces, and extra punctuation marks. Similarly, it may contain words that are badly cased, and the boundaries between paragraphs and sentences may not be clearly delineated.

In one study, 5,000 randomly collected electronic mail messages were examined, and it was found that 98.4% of the electronic mail messages contained different forms of noise. Because these types of noise often occur in raw text, natural language processing of raw text is not always as accurate or efficient as desired. It is difficult to determine how to properly process such raw text in order to make it more useful for natural language processing technologies.

In order to improve the quality of natural language processing on raw text, some have attempted to perform “normalization” on data that was informally input. Normalization of text is a process by which a textual input is modified so that it is in an expected form. For instance, some email messages are written in all lower case letters. Changing the case of a letter so it is grammatically correct is one text normalization operation. Of course, there are a variety of others as well.

Conventional text normalization systems are currently viewed as addressing an engineering issue and are conducted in an ad hoc manner. For example, some current text normalization systems perform independent text normalization while others perform cascaded text normalization. The independent approach to text normalization performs text normalization with several processing passes on the same text. All of the passes take the raw text as input. Each pass attempts to correct a single type of normalization error in the text, and outputs the normalized or clean result independently of other passes. The cascaded approach also performs normalization in several passes on the text. Each process (pass) attempts to correct a type of normalization error, taking as its input the output of the previous process.

These types of text normalization systems use rules or machine learned models. These types of conventional text normalization systems also simply address different types of noise (or normalization errors), in isolation from one another. In other words, a set of rules may be used in order to address one type of noise, while a second set of rules is used in order to address another type of noise. These types of noise are subjected to the rules, as they are encountered in the text stream, without reference to the other types of noise found in the text stream.

The discussion above is merely provided for general background information and is not intended to be used as an aid in determining the scope of the claimed subject matter.

### SUMMARY

Raw input text is received, and divided into sequences of tokens. Each token is marked with a text normalization tag that identifies a text normalization operation to be performed on the token during text normalization. The tags are assigned to the tokens by determining a most likely tag sequence, given the sequence of tokens being processed. The text normalization operations are performed on the tokens in order to provide clean output text, which can be output for further natural language processing.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one embodiment of a text normalization system.

FIG. 2 is a flow diagram illustrating the overall operation of the system shown in FIG. 1.

FIG. 3 shows the assignment of likely tags to an exemplary raw text input.

FIG. 4 is a block diagram of one illustrative computing environment.

### DETAILED DESCRIPTION

Text normalization can be defined at three different levels, and the subtasks for performing text normalization at the three different levels can also be identified. For example, in one embodiment, text normalization can be performed at the paragraph level, at the sentence level, or at the word level. The subtasks for performing text normalization at each of these exemplary levels can be those set out in Table 1 below.

TABLE 1

| | | Percentages of |
|---|---|---|
| Level | Task | Noises |
| Paragraph | Extra line break | 49.53 |
| | deletion | |
| | Paragraph boundary | — |
| | detection | |
| Sentence | Extra space | 15.58 |
| | deletion | |
| | Extra punctuation | 0.71 |
| | mark deletion | |
| | Missing space | 1.55 |
| | insertion | |
| | Missing punctuation | 3.85 |
| | mark insertion | |
| | Misused punctuation | 0.64 |
| | mark correction | |
| | Sentence boundary | — |
| | detection | |
| Word | Case restoration | 15.04 |
| | Unnecessary token | 9.69 |
| | deletion | |
| | Misspelled word | 3.41 |
| | correction | |

Table 1 shows that, for instance, in order to perform text normalization at the paragraph level, the two tasks include deleting extra line breaks between paragraphs and identifying paragraph boundaries. Table 1 also shows that, at the sentence level, text normalization can be performed by deleting extra spaces and punctuation marks, inserting spaces and punctuation marks, correcting misused punctuation marks, and identifying sentence boundaries. Text normalization at the word level can be performed by performing case restoration, deleting unnecessary tokens, and correcting misspelled words.

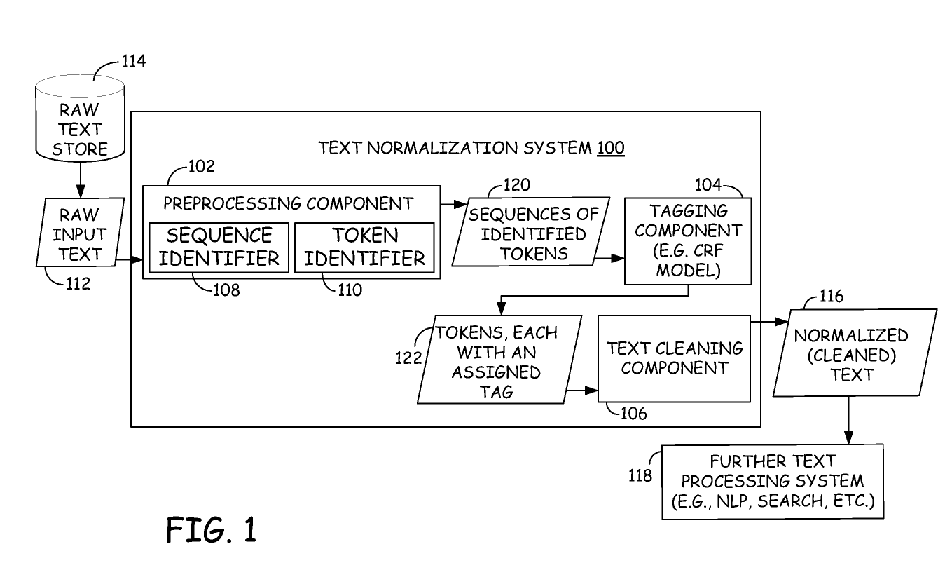

FIG. 1 is a block diagram of one embodiment of a text normalization system 100 for normalizing input text using at least some of the text normalization operations (or subtasks) shown in Table 1. Text normalization system 100 includes preprocessing component 102, tagging component 104 and text cleaning component 106. Preprocessing component 102, itself, includes sequence identifier 108 and token identifier 110. FIG. 1 also shows that text normalization system 100 receives raw input text 112 from a raw text data store 114, and outputs normalized (or cleaned) text 116 to a further text processing system (such as a natural language processor, a search system, etc.). The further text processing system is indicated by 118 in FIG. 1.

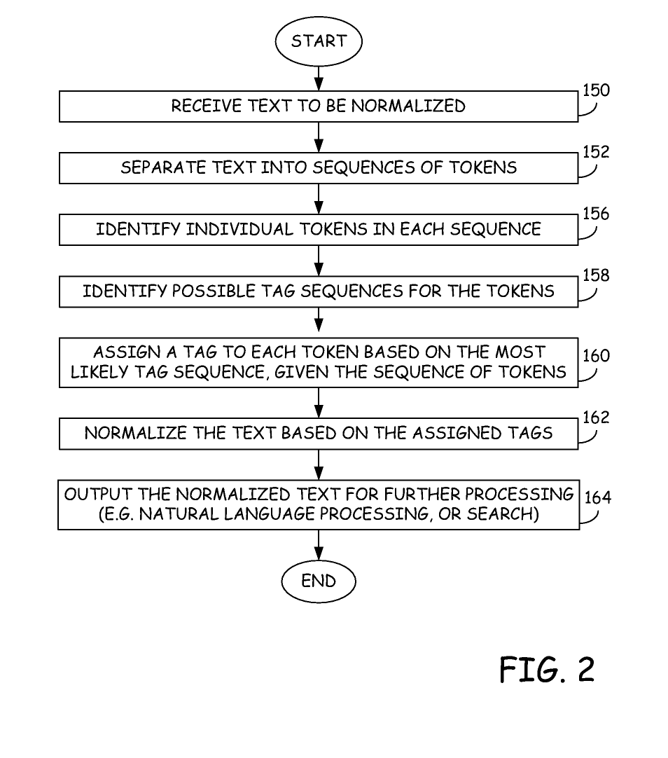

FIG. 2 is a flow diagram illustrating one embodiment of the overall operation of the system shown in FIG. 1. Text normalization system 100 is configured to normalize text, using a unified approach, regardless of whether processing is performed at the paragraph level, the sentence level, or the word level. In the embodiment shown in FIG. 1, preprocessing component 102 identifies individual tokens in the raw input text 112 and tagging component 104 assigns a normalization tag to each of the tokens. Text cleaning component 106 then performs text normalization operations on the components, based on the tags assigned, in order to provide normalized text 116.

More specifically, pre-processing component 102 first receives the raw input text 112, which is to be normalized. This is indicated by block 150 in FIG. 2. Raw input text 112 illustratively comes from a raw text store 114 which may store one or more of a wide variety of different sources of informally input (or noisy) text. Examples of the text stored in raw text store 115 include email messages, posts on newsgroups or forums, and writings from blogs. Of course, these are only exemplary sources for raw text, and others could be used as well.

Once raw input text 112 is received by pre-processing component 102, sequence identifier 108 identifies individual sequences of tokens in the input text 112. In the embodiment discussed herein, sequence identifier 108 illustratively divides raw input text 112 into paragraphs. Therefore, each paragraph is an individual sequence of tokens.

Identifying paragraphs in raw input text 112 can be performed using any of a wide variety of different mechanisms. In the embodiment discussed herein, text 112 is separated into paragraphs by identifying two or more consecutive line breaks as the endings of a paragraph. Therefore, at each point in raw input text 112 where two or more consecutive line breaks occur, sequence identifier 108 identifies that as the end of the preceding sequence. Separating raw input text 112 into sequences of tokens (e.g., into paragraphs) is indicated by Block 152 in FIG. 2.

Once individual sequences of tokens have been identified, they are provided to token identifier 110 which identifies individual tokens in each sequence. This can also be performed using any of a wide variety of different mechanisms. In the embodiment discussed herein, there are five different types of tokens identified. Those are standard word, non-standard word, punctuation mark, and a set of control characters that are non-printing characters in that they do not represent a written symbol. In the embodiment discussed herein, the control characters are space and line break.

Standard word tokens are words in natural language. Non-standard word tokens include several special words, such as email addresses, IP addresses, uniform resource locators (URLs), dates, number, money, percentage, unnecessary tokens (such as “===” and “###”), etc. Punctuation marks include period, question mark, and exclamation mark, where words and punctuation marks are separated into different tokens if they are joined together. Natural spaces and line breaks are also regarded as tokens.

Each of the five different types of tokens can illustratively be identified simply by using heuristics which are applied to a sequence of tokens in order to identify the individual tokens therein. Also, of course, a machine learned model, which is trained on annotated training data, can be used to identify tokens in an input sequence of tokens as well. Identifying individual tokens in each sequence of tokens is indicated by block 156 in FIG. 2. The sequences of tokens, wherein each token is identified in each sequence, are output by preprocessing component 102 as sequences of identified tokens 120.

Tagging component 104 illustratively identifies a most likely sequence of tags, given a sequence of tokens. In doing so, tagging component 104 may illustratively identify possible tag sequences for the tokens, as indicated by block 158 in FIG. 2. Then, tagging component 104 assigns a tag to each token in the sequence of tokens being processed, based on the most likely tag sequence, given the sequence of tokens. This is indicated by block 160 in FIG. 2.

The tags assigned by tagging component 104 correspond to text normalization operations which are to be performed on the corresponding token. Therefore, in one embodiment, the tags can call for a token to be deleted, preserved (or retained) or changed. Table 2 identifies a plurality of text normalization tags which can be assigned to each different type of token in a sequence of tokens.

TABLE 2

| Token Type | Tag | Description |
|---|---|---|
| Line break | PRV | Preserve line break |
| | RPA | Replace line break by space |
| | DEL | Delete line break |
| Space | PRV | Preserve space |
| | DEL | Delete space |
| Punctuation mark | PSB | Preserve punctuation mark and |
| | | view it as sentence ending |
| | PRV | Preserve punctuation mark without |
| | | viewing it as sentence ending |
| | DEL | Delete punctuation mark |
| Word | AUC | Make all characters in uppercase |
| | ALC | Make all characters in lowercase |
| | FUC | Make the first character in |
| | | uppercase |
| | AMC | Make characters in mixed case |
| Special token | PRV | Preserve the special token |
| | DEL | Delete the special token |

As shown in Table 2, a line break token can be preserved, deleted, or replaced by a space. A space token can be preserved or deleted. A punctuation mark token can be preserved and viewed as a sentence ending punctuation mark (such as a period or question mark, etc.), preserved without viewing it as a sentence ending punctuation mark (such as a hyphen or a comma, etc.) or deleted. A word token can be made to have all upper case characters, all lower case characters, have a first character in upper case, or to have characters in mixed case. Component 104 can be implemented using dynamic programming or a variety of different techniques, and one of them (a conditional random fields model) is discussed in greater detail below. The tokens, each having an assigned tag, are indicated by block 122 in FIG. 1.

In the embodiment shown in FIG. 2, the tags do not identify some of the tasks shown in Table 1, such as missing space insertion, missing punctuation mark insertion, and misspelled word correction. It has been observed that these types of text normalization operations fix only a relatively small percent of the noise in text normalization, but increase the search space required to identify a most likely sequence of tags. Similarly, while misspelled word correction can be performed relatively easily, it also corresponds to a relatively small percent of noise in the data. Of course, in applications where higher accuracy is desired, those tags can be used as well. However, in applications where the higher accuracy is not absolutely required and where computational overhead is to be kept lower, those tags need not be used, yet the system can still be implemented to normalize a vast majority of the noise in text.

Similarly, misused punctuation marks (such as replacing a period with a question mark) only account for an extremely small percent of the noise in the data. Therefore, the text normalization operation to correct such errors is not performed either. However, where extremely accurate text normalization is desired, it can be implemented in the same way as the other text normalization tasks discussed herein.

The tokens with assigned tags 122 are provided to text cleaning component 106. Text cleaning component 106 normalizes the text by performing the text normalization operation, indicated by the tag, on each corresponding token. Therefore, when a token is tagged with a tag indicating that it should be deleted, component 106 deletes that token. When a token is simply tagged with a tag indicating it should be preserved, then that token is preserved, etc. Normalizing the text based on the assigned tags is indicated by block 162 in FIG. 2.

The normalized text 116 is then cleaned text, which can be provided to further text processing system 118. Because the text has been cleaned, the further text processing will likely be far more successful than if it were performed on noisy text. Outputting the normalized text for further processing is indicated by block 164 in FIG. 2.

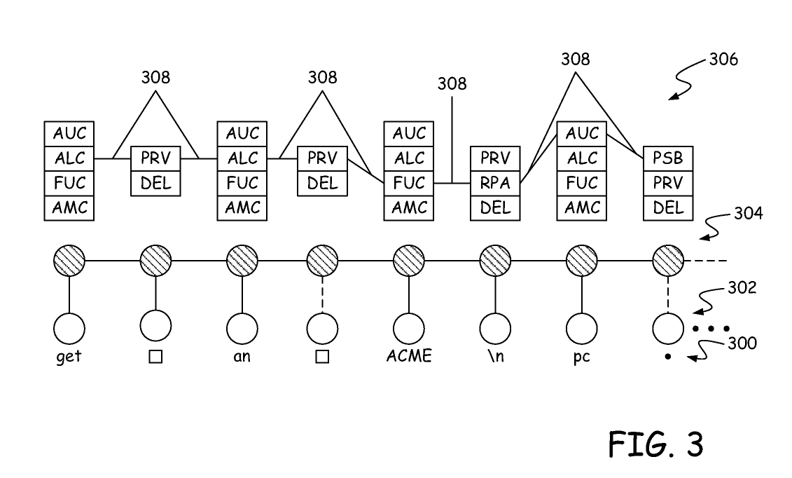

An example may be helpful. FIG. 3 illustrates an example of the tagging procedure implemented by tagging component 104 on a raw input text. The raw input text is “get an ACME\n pc.” This input text is indicated at 300 in FIG. 3, and the boxes correspond to the space token. The \n corresponds to the line break. Also, in FIG. 3, the row of clear circles 302 each correspond to a token, and the shaded circles 304 each correspond to a tag chosen for the corresponding token.

As shown in Table 2 above, each of the tokens can be assigned one of a plurality of possible tags. The tags corresponding to each type of token in text 300 are shown above the token circles 304, generally at 306 in FIG. 3. Therefore, for instance, the first token in the input sequence 300 of tokens is the word “get”. As shown in Table 2, a word can have one of four possible text normalization tags. Those text normalization tags are shown above the shaded circle 304 corresponding to the token “get”. Similarly, the second token in sequence 300 is a space token. As shown in Table 2, a space token can have one of two text normalization tags, and those are identified above the shaded circle 304 corresponding to the space token.

In one embodiment, tagging component 104 comprises a conditional random fields model that identifies a most likely sequence of tags 306, given the sequence of tokens 300. The most likely sequence of tags 306 for the input shown in FIG. 3 are those tags connected by connecting lines 308. Therefore, the tag sequence corresponding to the token sequence 300 is ALC, PRV, ALC, PRV, FUC, RPA, AUC, PSB.

Based on these tags, text cleaning component 106 performs the corresponding text normalization operations on the tokens to which each tag is assigned. This results in a normalized text 116 which is output for further natural language processing.

In the embodiment in which the conditional random fields model is employed as tagging component 104, the conditional random fields is a conditional probability distribution of a sequence of tags, given a sequence of tokens, represented as P(X|Y), where X denotes the token sequence and Y denotes the tag sequence.

In performing the tagging operation, the conditional random fields model employed as component 104 is used to find the sequence of tags Y* having the highest likelihood, where:

Y*=max_{Y}P(Y|X) Equation 1

This can be done using an efficient algorithm, which may illustratively be the known Viterbi algorithm or other dynamic programming algorithm.

In order to train such a CRF model, labeled data is provided to a training component and an iterative algorithm, such as one based on Maximum Likelihood Estimation, is used to train the model. In one embodiment, two sets of features are defined in the CRF model. Those are transition features and state features. Table 3 shows one illustrative set of transition features and state features used in training a model for tagging component 104.

TABLE 3
Transition Features

yᵢ₋₁ = y′, yᵢ = y
yᵢ₋₁ = y′, yᵢ = y, wᵢ = w
yᵢ₋₁ = y′, yᵢ = y, tᵢ = t

State Features

| | |
|---|---|
| wᵢ = w, yᵢ = y | tᵢ = t, yᵢ = y |
| wᵢ₋₁ = w, yᵢ = y | tᵢ₋₁ = t, yᵢ = y |
| wᵢ₋₂ = w, yᵢ = y | tᵢ₋₂ = t, yᵢ = y |
| wᵢ₋₃ = w, yᵢ = y | tᵢ₋₃ = t, yᵢ = y |
| wᵢ₋₄ = w, yᵢ = y | tᵢ₋₄ = t, yᵢ = y |
| wᵢ₊₁ = w, yᵢ = y | tᵢ₊₁ = t, yᵢ = y |
| wᵢ₊₂ = w, yᵢ = y | tᵢ₊₂ = t, yᵢ = y |
| wᵢ₊₃ = w, yᵢ = y | tᵢ₊₃ = t, yᵢ = y |
| wᵢ₊₄ = w, yᵢ = y | tᵢ₊₄ = t, yᵢ = y |
| wᵢ₋₁ = w′, wᵢ = w yᵢ = y | tᵢ₋₂ = t″, tᵢ₋₁ = t, yᵢ = y |
| wᵢ₊₁ = w′, wᵢ = w yᵢ = y | tᵢ₋₁ = t′, tᵢ = t, yᵢ = y |
| | tᵢ = t, tᵢ₊₁ = t′, yᵢ = y |
| | tᵢ₊₁ = t′, tᵢ₊₂ = t″, yᵢ = y |
| | tᵢ₋₂ = t″, tᵢ₋₁ = t′, yᵢ = y |
| | tᵢ₋₁ = t, tᵢ = t, tᵢ₊₁ = t′, yᵢ = y |
| | tᵢ = t, tᵢ₊₁ = t′, tᵢ₊₂ = t″, yᵢ = y |

Suppose that in position i in token sequence x, wᵢ is the token, tᵢ is the type of token (such as those shown in Table 2), and yᵢ is a possible tag assigned to that token. Binary features are identified as described in Table 3. For example, the transition feature yᵢ₋₁=y^{3′}, yᵢ=y implies that if the current tag is y and the previous tag is y′, the feature value is true; otherwise the feature value is false. The state feature wᵢ=w, yᵢ=y, implies that if the current token is w and the current label is y, then the feature value is true; otherwise it is false. By way of example, one feature might be “the word at position five is “PC” and the current tag is “AUC”. The actual features used to train any particular tagging component 104 can be empirically determined, given a set of training data, and given what particular types of text normalization errors are being corrected by the text normalization system. For instance, there may be several million features defined for a given model.

It can be seen that, in contrast to prior independent or cascaded approaches, the present system can be advantageous. Some text normalization tasks are interdependent. The cascaded or independent approach cannot simultaneously perform the text normalization tasks. In contrast, the present system can effectively overcome this drawback by employing a unified tagging framework and thus achieve more accurate performance.

Similarly, there are many specific types of errors that must be corrected in text normalization. If one defines a specialized model or rule to handle each of the cases, the number of needed models or rules is extremely large, and thus the text normalization processing can quickly become impractical. In contrast, the present system naturally formalizes all the tasks as assignments of different types of tags, and trains a unified model to address all the problems at once.

An example of how the three approaches (independent, cascaded and unified) normalize text may be helpful. Table 4 shows the results of the three different text normalization techniques (independent, cascaded, and unified performed on the following informal (or noisy) text input:

1. “1. i'm thinking about buying a pocket

2. pc device for my wife this Christmas,.

3. the worry that I have is that she won't

4. be able to sync it to her outlook express

5. contacts . . . ”

TABLE 4

INDEPENDENT
“I'm thinking about buying a pocket PC device for my wife
this Christmas, The worry that Ihave is that she won't be
able to sync it to her outlook express contacts.//”
CASCADED
I'm thinking about buying a pocket PC device for my wife
this Christmas, the worry that Ihave is that she won't be
able to sync it to her outlook express contacts.//
UNIFIED
I'm thinking about buying a Pocket PC device for my wife
this Christmas.// The worry that Ihave is that she won't
be able to sync it to her Outlook Express contacts.//”

Table 4 shows that the independent method can correctly deal with some of the errors. For instance, it can capitalize the first word in the first and third line, remove extra periods in the fifth line, and remove the four extra line breaks. However, it mistakenly removes the period in the second line and it cannot restore the cases of some words, for example “pocket” and “outlook express”.

In the cascaded method, each process carries out cleaning or text normalization from the output of the previous process and thus can make use of the cleaned or normalized results from the previous process. However, errors in the previous process also propagate to the later processes. For example, the cascaded method mistakenly removes the period in the second line. The error allows case restoration to make the error of keeping the word “the” in lower case. These two methods tend to restore cases of words to the forms having higher probabilities in the data set and cannot take advantage of the dependencies of other normalization subtasks. For example, “outlook” might be restored to first letter capitalized in both “outlook express” and “a pleasant outlook”. However, the present system can take advantage of dependencies with other subtasks and thus correct in excess of 85% of the errors that the independent and cascaded methods cannot address.

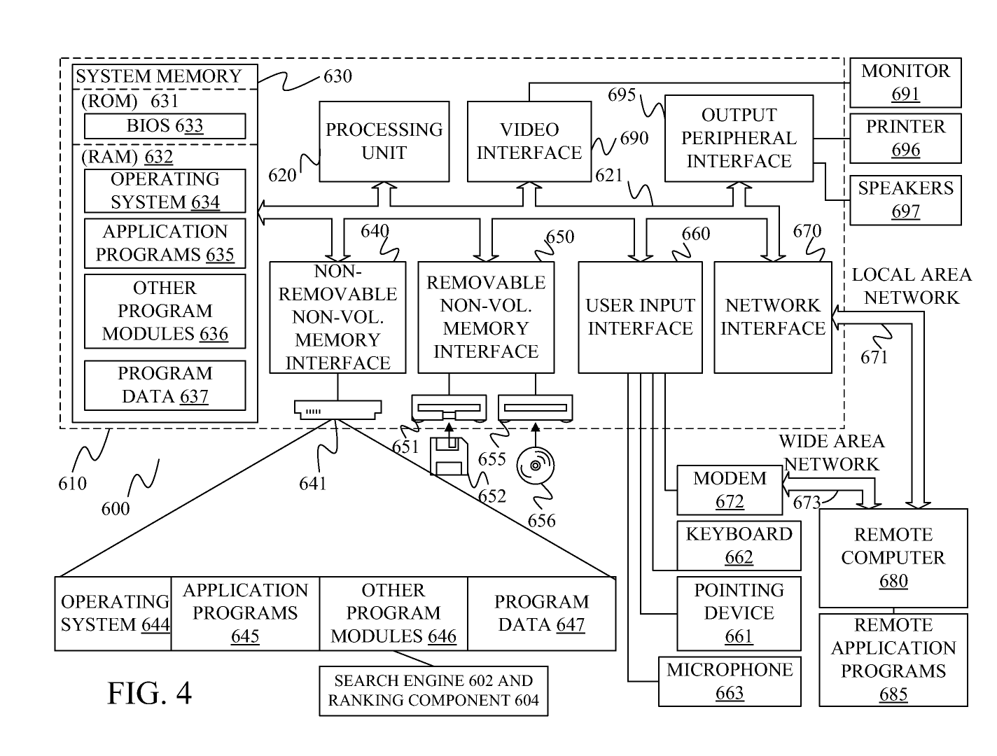

FIG. 4 is one embodiment of a computing environment in which the invention can be used. With reference to FIG. 4, an exemplary system for implementing some embodiments includes a general-purpose computing device in the form of a computer 610. Components of computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 610 typically includes a variety of computer readable media. Computer readable media can be any available media that can be accessed by computer 610 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 610. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 4 illustrates operating system 634, application programs 635, other program modules 636, and program data 637. The systems discussed above in FIGS. 1-3 can be stored in other program modules 636 or elsewhere, including being stored remotely.

The computer 610 may also include other removable/non-removable volatile/nonvolatile computer storage media. By way of example only, FIG. 4 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media discussed above and illustrated in FIG. 4, provide storage of computer readable instructions, data structures, program modules and other data for the computer 610. In FIG. 4, for example, hard disk drive 641 is illustrated as storing operating system 644, application programs 645, other program modules 646, and program data 647. Note that these components can either be the same as or different from operating system 634, application programs 635, other program modules 636, and program data 637. Operating system 644, application programs 645, other program modules 646, and program data 647 are given different numbers here to illustrate that, at a minimum, they are different copies. They can also include search components 602 and 604.

FIG. 4 shows the clustering system in other program modules 646. It should be noted, however, that it can reside elsewhere, including on a remote computer, or at other places.

A user may enter commands and information into the computer 610 through input devices such as a keyboard 662, a microphone 663, and a pointing device 661, such as a mouse, trackball or touch pad. Other input devices (not shown) may include a joystick, game pad, satellite dish, scanner, or the like. These and other input devices are often connected to the processing unit 620 through a user input interface 660 that is coupled to the system bus, but may be connected by other interface and bus structures, such as a parallel port, game port or a universal serial bus (USB). A monitor 691 or other type of display device is also connected to the system bus 621 via an interface, such as a video interface 690. In addition to the monitor, computers may also include other peripheral output devices such as speakers 697 and printer 696, which may be connected through an output peripheral interface 695.

The computer 610 is operated in a networked environment using logical connections to one or more remote computers, such as a remote computer 680. The remote computer 680 may be a personal computer, a hand-held device, a server, a router, a network PC, a peer device or other common network node, and typically includes many or all of the elements described above relative to the computer 610. The logical connections depicted in FIG. 4 include a local area network (LAN) 671 and a wide area network (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660, or other appropriate mechanism. In a networked environment, program modules depicted relative to the computer 610, or portions thereof, may be stored in the remote memory storage device. By way of example, and not limitation, FIG. 4 illustrates remote application programs 685 as residing on remote computer 680. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of normalizing input text, comprising:
identifying a continuous sequence of a plurality of tokens in the input text, the tokens including individual words and control characters in the input text;
assigning each token in the continuous sequence a corresponding normalization tag, to obtain tagged tokens, each normalization tag identifying a normalization operation to perform on the corresponding token;
after the normalization tags are assigned to each token in the continuous sequence, performing the normalization operations on the tagged tokens to obtain normalized text; and
outputting the normalized text to a text processing system.

2. The method of claim 1 the normalization operation identified by each tag comprises one of a set of normalization operations, the set including preserving the corresponding token, deleting the corresponding token, and modifying the corresponding token.

3. The method of claim 1 wherein assigning each token a corresponding normalization tag comprises:
calculating a most likely continuous tag sequence of normalization tags, given the continuous sequence of tokens; and
assigning the normalization tags in the continuous tag sequence to the tokens in the continuous sequence of tokens.

4. The method of claim 3 wherein calculating a most likely continuous tag sequence comprises:
accessing a conditional random fields model, given the continuous sequence of tokens, to obtain the most likely continuous tag sequence.

5. The method of claim 1 and further comprising:
separating the input text into a plurality of different continuous sequences of tokens.

6. The method of claim 5 wherein separating the input text into a plurality of different continuous sequences of tokens, comprises:
separating the input text into paragraphs.

7. The method of claim 5 wherein separating the input text into a plurality of different continuous sequences of tokens, comprises:
separating the input text into sentences.

8. The method of claim 1 wherein assigning the normalization tags assigns the normalization tags to the continuous sequence of tokens to identify normalization operations that collectively correct a plurality of different types of normalization errors in the continuous sequence of tokens.

9. The method of claim 8 wherein the different types of normalization errors include normalization errors that are interdependent errors in that an error in one token affects an error in another token in the continuous stream of tokens.

10. A text processing system, comprising:
a pre-processing component that receives input text and divides the input text into a sequence of tokens;
a tagging component that assigns normalization tags to all tokens in the sequence of tokens that are to be normalized, each tag representing one of a plurality of different types of normalization operations that are to be performed on the tokens in the sequence of tokens to correct a plurality of different types of errors in the input text; and
a text cleaning component performing the normalization operations identified by the normalization tags on the tokens to obtain normalized text and outputting the normalized text.

11. The text processing system of claim 10 wherein the tagging component comprises a dynamic programming component configured to calculate a likely tag sequence, given the sequence of tokens.

12. The text processing system of claim 10 wherein the tagging component comprises:
a conditional random fields model.

13. The text processing system of claim 10 and further comprising:
a raw text store storing a corpus of raw text to be provided as the input text.

14. The text processing system of claim 13 wherein the plurality of different types of normalization operations comprise at least three of preserving a token, deleting a token and modifying case of characters in a token.

15. The text processing system of claim 10 wherein the pre-processing component comprises:
a sequence identifier that receives the input text and divides it into a plurality of different sequences of tokens.

16. The text processing system of claim 15 wherein the pre-processing component comprises:
a token identifier that identifies individual tokens in each of the plurality of sequences of tokens.

17. The text processing system of claim 15 wherein the plurality of different sequences of tokens comprise at least one of paragraphs, sentences and words.

18. A computer readable storage medium encoded with computer readable instructions which, when executed by a computer, cause the computer to perform steps of:
identifying individual paragraphs in an input text;
for each given paragraph identified, identifying individual tokens in the given paragraph, the tokens comprising words, punctuation marks and control characters in the given paragraph;
assigning, based on the tokens identified in the given paragraph, a sequence of normalization tags to the words, punctuation marks, and control characters identified in the given paragraph, each normalization tag representing a normalization operation to be performed on the token to which the tag is assigned;
after assigning the sequence of normalization tags to the words, punctuation marks and control characters identified in the given paragraph, performing the normalization operations on each of the tokens, given the tags assigned to the tokens; and
outputting the paragraph after the normalization operations have been performed.

19. The computer readable medium of claim 18 wherein assigning a sequence of normalization tags comprises:
calculating a most likely sequence of normalization tags given the sequence of words, punctuation marks and control characters identified in the given paragraph; and
assigning the most likely sequence of normalization tags to the sequence of words, punctuation marks and control characters in the paragraph.

20. The computer readable medium of claim 18 wherein the step of performing the normalization operations on the tokens in the given paragraph is performed after tags are assigned to every token identified in the given paragraph.
